(19) United States
(12) Patent Application Publication
(10) Pub. No.: US 2026/0160916 A1
(43) Pub. Date: Jun. 11, 2026

(54) METHOD AND SYSTEM FOR DETERMINING ATTENUATED SEISMIC TIME USING MACHINE LEARNING

(71) Applicant: SAUDI ARABIAN OIL COMPANY, Dhahran (SA)

(72) Inventor: Yi He, Beijing (CN)

(73) Assignee: SAUDI ARABIAN OIL COMPANY, Dhahran (SA)

(21) Appl. No.: 18/723,910

(22) PCT Filed: Jun. 21, 2023
(86) PCT No.: PCT/CN2023/101619

§ 371 Date: Jun. 25, 2024

(51) Int. Cl. G01V 1/50; E21B 43/16

(52) U.S. Cl. CPC G01V 1/50; E21B 43/16; E21B 2200/22

(57) ABSTRACT

A method may include determining various seismic traveltimes using seismic parameter data, an Eikonal function, and a velocity model for the geological region of interest (420). The method may further include determining various computed attenuated traveltimes using an attenuation model for the geological region of interest, an attenuated Eikonal function, the seismic traveltimes, and the seismic parameter data (430). The method may further include determining various predicted attenuated traveltimes using a machine-learning model and the seismic parameter data (440). The method may further include determining error data using a loss function based on a mismatch between the predicted attenuated traveltimes and the computed attenuated traveltimes (450). The method may further include determining whether the machine-learning model satisfies a predetermined criterion based on the error data (460). The method may further include updating the machine-learning model using a machine-learning algorithm to produce an updated machine-learning model (470).

### BACKGROUND

Various seismic processing operations are performed on seismic data from a survey to convert time-based seismic data into a depth representation of a subsurface. For example, seismic processing operations may include surface multiple filtering and other seismic data correction operations. Likewise, seismic processing may also include application of seismic inversion techniques and migration algorithms to determine or update velocity models.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining seismic parameter data based on a seismic survey regarding a geological region of interest. The method further includes determining, by a computer processor, various seismic traveltimes using the seismic parameter data, an Eikonal function, and a velocity model for the geological region of interest. The method further includes determining, by the computer processor, various computed attenuated traveltimes using an attenuation model for the geological region of interest, an attenuated Eikonal function, the seismic traveltimes, and the seismic parameter data. The method further includes determining, by the computer processor, various predicted attenuated traveltimes using a machine-learning model and the seismic parameter data. The method further includes determining, by the computer processor, error data using a loss function based on a mismatch between the predicted attenuated traveltimes and the computed attenuated traveltimes. The method further includes determining, by the computer processor, whether the machine-learning model satisfies a predetermined criterion based on the error data. The method further includes updating, by the computer processor, the machine-learning model using a machine-learning algorithm to produce an updated machine-learning model in response to the error data failing to satisfy the predetermined criterion. The method further includes determining, by the computer processor, various predicted attenuated traveltimes using the updated machine-learning model and the seismic parameter data.

In general, in one aspect, embodiments relate to a system that includes a parallel processing network that includes various parallel processors and a seismic interpreter that includes a computer processor. The seismic interpreter is coupled to the parallel processing network. The seismic interpreter obtains seismic parameter data based on a seismic survey regarding a geological region of interest. The seismic interpreter further determines various seismic traveltimes using the seismic parameter data, an Eikonal function, and a velocity model for the geological region of interest. The seismic interpreter further determines various computed attenuated traveltimes using an attenuation model for the geological region of interest, an attenuated Eikonal function, the seismic traveltimes, and the seismic parameter data. The seismic interpreter further determines various predicted attenuated traveltimes using a machine-learning model and the seismic parameter data. The seismic interpreter further determines error data using a loss function based on a mismatch between the predicted attenuated traveltimes and the computed attenuated traveltimes. The seismic interpreter further determines whether the machine-learning model satisfies a predetermined criterion based on the error data. The seismic interpreter further updates the machine-learning model using a machine-learning algorithm to produce an updated machine-learning model in response to the error data failing to satisfy the predetermined criterion. The seismic interpreter further determines various predicted attenuated traveltimes using the updated machine-learning model and the seismic parameter data.

In some embodiments, various grid nodes are determined in the geological region of interest using seismic parameter data. The grid nodes may include a first subset of grid nodes and a second subset of grid nodes. Various attenuated traveltimes may be determined using an attenuation model, an attenuated Eikonal function, various seismic traveltimes, and the seismic parameter data to produce a training dataset. The computed attenuated traveltimes may be determined using a finite-difference method and the first subset of grid nodes. A machine-learning model may be trained using the training dataset and a machine-learning algorithm to produce a trained model. Various predicted attenuated traveltimes may be determined using the trained model, the seismic parameter data, and the second subset of grid nodes. In some embodiments, error data is based a mismatch between various computed attenuated traveltimes and various predicted attenuated traveltimes for various partial-differential equations. and, A loss function may be a mean-squared-error (MSE) norm function. In some embodiments, error data includes a first contribution and a second contribution. The first contribution may be based on various boundary conditions and a first mismatch between various computed attenuated traveltimes and various predicted attenuated traveltimes. The second contribution may be based on various regularization terms and a second mismatch between the computed attenuated traveltimes and the predicted attenuated traveltimes.

In some embodiments, seismic parameter data includes various seismic source locations, various seismic receiver locations, and grid data. The grid data may describe various grid nodes disposed between a respective seismic source among various seismic sources and a respective seismic receiver among various seismic receivers. In some embodiments, a training dataset is determined that includes various computed attenuated traveltimes that are determined using an attenuated Eikonal function. A training operation of a machine-learning model may be performed using the training dataset and a machine-learning algorithm. The machine-learning model may be updated iteratively using various machine-learning epochs until the predetermined criterion is satisfied.

In some embodiments, a machine-learning model is an artificial neural network that includes an input layer, various hidden layers, and an output layer. A machine-learning algorithm may be a backpropagation algorithm. A predetermined criterion may be a predetermined level of accuracy. In some embodiments, an attenuation model is a Q model that describes various seismic quality factor values for a geological region of interest. In some embodiments, a seismic surveying system includes various seismic receivers and a seismic source, and the seismic surveying system is used to acquire seismic data regarding a geological region of interest. A velocity model and seismic parameter data may be based on the seismic data. In some embodiments, a seismic image is generated for a geological region of interest based on various predicted attenuated traveltimes. Various interfaces within the geological region of interest may be determined using one or more frequency-dependent attenuation regions in an attenuation model. A presence of hydrocarbons in the geological region of interest may be determined using the interfaces.

In some embodiments, a seismic image is generated for a geological region of interest based on various predicted attenuated traveltimes. A well path may be determined in the geological region of interest using the seismic image. A drilling operation may be performed using a drilling system and based on the well path. In some embodiments, various parallel processors are disposed in a graphical processing unit (GPU). In some embodiments, a seismic surveying system includes various seismic receivers and a seismic source. The seismic surveying system may be coupled to a seismic interpreter. The seismic surveying system may acquire seismic data regarding a geological region of interest. A velocity model and seismic parameter data may be based on the seismic data In some embodiments, a drilling system includes a drill bit and a drill string. The drilling system may be coupled to a seismic interpreter. The seismic interpreter may generate a seismic image based on various predicted attenuated traveltimes. The drilling system may perform a drilling operation based on a well path that is based on the seismic image.

In light of the structure and functions described above, embodiments of the invention may include respective means adapted to carry out various steps and functions defined above in accordance with one or more aspects and any one of the embodiments of one or more aspect described herein.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, and 3 show systems in accordance with one or more embodiments.

FIG. 4 shows a flowchart in accordance with one or more embodiments.

FIGS. 5, 6A, 6B, 6C, 7A, 7B, 7C, and 8 show examples in accordance with one or more embodiments.

FIG. 9 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining seismic attenuated traveltimes using a machine-learning framework. In some embodiments, for example, a machine-learning model is used to predict attenuated traveltimes of pressure waves traveling through a subsurface without using conventional ray tracing. Attenuated traveltimes may correspond to the amount of time that pressure waves dissipate in the subsurface due to absorption/attenuation characteristics of different geological media (e.g., isotropic and anisotropic media). Likewise, this machine-learning model may provide a functional approximation of a mathematical workflow for determining solutions to one or more attenuated Eikonal equations. In particular, an attenuated Eikonal equation may be used to simulate attenuation and absorption of pressure waves. While a small portion of attenuated traveltimes may be determined through a computational operation using a velocity model, an attenuation model, and a differential-equation solver (e.g., a finite difference method) for the attenuated Eikonal equation, the majority of attenuated traveltime values may be predicted using an inference operation performed by a machine-learning model.

In some embodiments, the machine-learning model is trained simultaneously on computed traveltime data and the governing differential equations associated with one or more Eikonal functions. In other words, a training operation may work in parallel with a seismic data processing operation that computes attenuated traveltimes. The output of the seismic processing operation may part of a feedback loop to a training operation for use as a training dataset for the machine-learning model. Accordingly, before this seismic processing operation determines a complete attenuated traveltime dataset, the machine-learning model may be sufficiently trained in order to predict the remaining portion of the attenuated traveltimes.

Keeping with this machine-learning workflow, a machine-learning model may be one or more physics-informed neural networks (PINNs), such as a deep neural network. A physics-informed neural network may be trained using computed solutions to various partial-differential equations (PDEs) associated with various Eikonal functions and geological media. More specifically, the physics-informed neural network may by a feed-forward artificial neural network that leverages automatic differentiation between computed values in different dimensions for different partial-differential equations (e.g., one partial-differential equation for the pressure waves in the x-dimension and another partial-differential equation for pressure waves in the z-dimension). A loss function for training a physics-informed neural network may be based on different partial-differential equations selected based on known geology of the subsurface. If an underlying geological medium changes, for example, one or more partial-differential equations may be adjusted or replaced in the loss function to produce a different trained model for accurately predicting attenuated traveltimes.

Furthermore, some embodiments use a finite difference method based on dividing a geological region along a grid system to compute attenuated traveltimes. For example, a geological region may be divided into various grid nodes where seismic traveltimes may be determined by solving an Eikonal equation with a differential-equation solver. In contrast to an inference operation, a traditional way of simulating attenuated traveltimes may include computing ray paths over the different grid nodes from seismic sources to seismic receivers, such as to produce a traveltime curve. For example, a seismic source may be the initial node in a traveltime curve and the seismic receiver may be the last node in the traveltime curve. However, irregular topography for different geological media may make ray tracing computationally intensive for a computer network. Additionally, the accuracy of computed attenuated traveltimes may depend on particular grid spacings in the modeling process, where smaller grid spacing may increase accuracy as well as the required computational time. By using a trained machine-learning model, attenuated traveltimes may be determined for pressure waves anywhere in the corresponding geological region without being limited to the location of nodes in a chosen grid system.

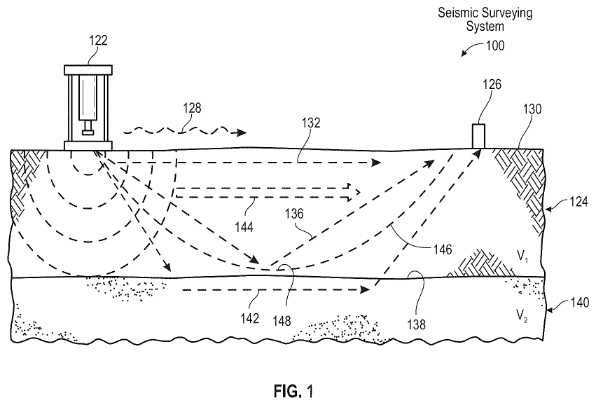

Turning to FIG. 1, FIG. 1 shows a schematic diagram in accordance with one or more embodiments. As shown in FIG. 1, FIG. 1 illustrates a seismic surveying system (100) and various resultant paths of pressure waves (also called seismic waves). The seismic surveying system (100) includes a seismic source (122) that includes functionality for generating pressure waves, such as a reflected wave (136), refracting wave (142), or diving wave (146), through a subsurface layer (124). Pressure waves generated by the seismic source (122) may travel along several paths through a subsurface layer (124) at a velocity V₁ for detection at a number of seismic receivers (126) along the line of profile. Likewise, velocity may refer to multiple velocities types, such as the two types of particle motions resulting from a seismic wave, i.e., velocity of the primary wave (P-wave) and a different velocity of the secondary wave (S-wave) through a particular medium. The seismic source (122) may be a seismic vibrator, such as one that uses a vibroseis technique, an air gun in the case of offshore seismic surveying, explosives, etc. The seismic receivers (126) may include geophones, hydrophones, accelerometers, and other sensing devices. Likewise, seismic receivers (126) may include single component sensors and/or multi-component sensors that measure pressure waves in multiple spatial axes.

As shown in FIG. 1, the seismic source (122) generates an air wave (128) formed by a portion of the emitted seismic energy, which travels above the earth's surface (130) to the seismic receivers (126). The seismic source (122) may also emit surface waves (132), which travel along the earth's surface (130). The speed of the surface waves (132), also called Rayleigh waves or ground roll, may correspond to a velocity typically slower than the velocity of a secondary wave. While the seismic surveying shown in FIG. 1 is a two-dimensional survey along a seismic profile along a longitudinal direction, other embodiments are contemplated, such as three-dimensional surveys.

Furthermore, subsurface layer (124) has a velocity V₁, while subsurface layer (140) has a velocity V₂. In words, different subsurface layers may correspond to different velocity values. In particular, a velocity may refer to the speed that a pressure wave travels through a medium, e.g., diving wave (146) that makes a curvilinear ray path (148) through subsurface layer (124). Velocity may depend on a particular medium's density and elasticity as well as various wave properties, such as the frequency of an emitted pressure wave. Where a velocity differs between two subsurface layers, this seismic impedance mismatch may result in a seismic reflection of a pressure wave. For example, FIG. 1 shows a pressure wave transmitted downwardly from the seismic source (122) to a subsurface interface (138), which becomes a reflected wave (136) transmitted upwardly in response to the seismic reflection. The seismic source (122) may also generate a direct wave (144) that travels directly from the seismic source (122) at the velocity V₁ through the subsurface layer (124) to the seismic receivers (126).

Turning to refracted pressure waves and diving pressure waves, the seismic source (122) may also generate a refracted wave (i.e., refracting wave (142)) that is refracted at the subsurface interface (138) and travels along the subsurface interface (138) for some distance as shown in FIG. 1 until traveling upwardly to the seismic receivers (126). As such, refracted pressure waves (e.g., refracted wave (142)) may be analyzed to map the subsurface layers (124, 140). For example, a refracted wave is a wave that a portion of ray path is along an interface of a reflector as show in refracting wave (142) in FIG. 1 (i.e., refraction exists only when V₂>V₁). On the other hand, a diving wave may be generated where velocities are gradually increasing with depth at a gradient (e.g., diving wave (146)), such that the diving wave may turn back along curvilinear ray path. Likewise, the apex of a diving wave may be consistent with a reflected seismic wave in a common midpoint (CMP) gather.

Furthermore, in analyzing seismic data acquired using the seismic surveying system (100), seismic wave propagation may be approximated using rays. For example, reflected waves (e.g., reflected wave (136)) and diving waves (e.g., diving wave (146)) may be scattered at the subsurface interface (138). In FIG. 1, for example, the diving wave (146) may exhibit a ray path of a wide angle that resembles a reflected wave in order to map the subsurface. Using diving waves, for example, a velocity model for an underlying subsurface may be generated that describes the velocity of different regions in different subsurface layers. An initial velocity model may be generated by modeling the velocity structure of media in the subsurface using an inversion of seismic data, typically referred to as seismic inversion. In seismic inversion, a velocity model is iteratively updated until the velocity model and the seismic data have a minimal amount of mismatch, e.g., the solution of the velocity model converges to a minimum that satisfies a predetermined criterion. For example, the optimization algorithm may be “linearized” and while achieving a “minimum”, there may be no guarantee that it is a global minimum rather than a local minimum. Thus, it may be a simplification commonly adapted in solving inverse problems that works when a respective objective function is convex.

With respect to velocity models, a velocity model may map various subsurface layers based on velocities in different layer sub-regions (e.g., P-wave velocity, S-wave velocity, and various anisotropic effects in the sub-region). For example, a velocity model may be used with P-wave and S-wave arrival times and arrival directions to locate seismic events. Anisotropy effects may correspond to subsurface properties that cause pressure waves to be directionally dependent. Thus, seismic anisotropy may correspond to various parameters in geophysics that refers to variations of wave velocities based on direction of propagation. One or more anisotropic algorithms may be performed to determine anisotropic effects, such as an anisotropic ray-tracing location algorithm or algorithms that use deviated-well sonic logs, vertical seismic profiles (VSPs), and core measurements. Likewise, a velocity model may include various velocity boundaries that define regions where rock types change, such as interfaces between different subsurface layers. In some embodiments, a velocity model is updated using one or more tomographic updates to adjust the velocity boundaries in the velocity model.

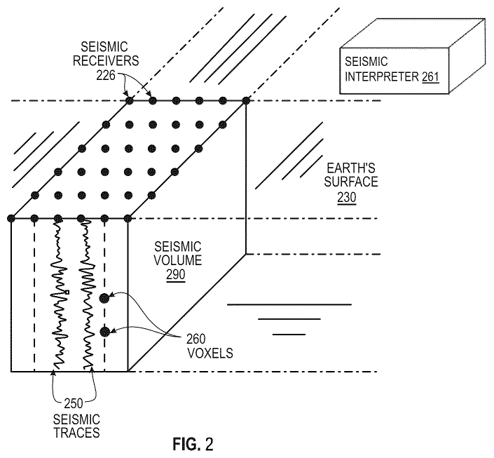

Turning to FIG. 2, FIG. 2 illustrates a system in accordance with one or more embodiments. As shown in FIG. 2, a seismic volume (290) is illustrated that includes various seismic traces (e.g., seismic traces (250)) acquired by various seismic receivers (e.g., seismic receivers (226)) disposed on the earth's surface (230). More specifically, a seismic volume (290) may be a cubic dataset of seismic traces. In particular, seismic data may have up to four spatial dimensions, one temporal dimension (i.e., related to the actual measurements stored in the traces), and possibly another temporal dimension related to time-lapse seismic surveys. Individual cubic cells within the seismic volume (290) may be referred to as voxels or volumetric pixels (e.g., voxels (260)). In particular, different portions of a seismic trace may correspond to various depth points within a volume of earth. To generate the seismic volume (290), a three-dimensional array of seismic receivers (226) are disposed along the earth's surface (230) and acquire seismic data in response to various pressure waves emitted by seismic sources. Within the voxels (260), statistics may be calculated on first break data that is assigned to a particular voxel to determine multimodal distributions of wave traveltimes and derive traveltime estimates (e.g., according to mean, median, mode, standard deviation, kurtosis, and other suitable statistical accuracy analytical measures) related to azimuthal sectors. First break data may describe the onset arrival of refracted waves or diving waves at the seismic receivers (226) as produced by a particular seismic source signal generation.

Seismic data may refer to raw time domain data acquired from a seismic survey (e.g., acquired seismic data may result in the seismic volume (290)). However, seismic data may also refer to data acquired over different periods of time, such as in cases where seismic surveys are repeated to obtain time-lapse data. Seismic data may also refer to various seismic attributes derived in response to processing acquired seismic data. Furthermore, in some contexts, seismic data may also refer to depth data or image data. Likewise, seismic data may also refer to processed data, e.g., using a seismic inversion operation, to generate a velocity model of a subterranean formation, or a migrated seismic image of a rock formation within the earth's surface. Seismic data may also be pre-processed data, e.g., arranging time domain data within a two-dimensional shot gather.

Furthermore, seismic data may include various spatial coordinates, such as (x,y) coordinates for individual shots and (x,y) coordinates for individual receivers. As such, seismic data may be grouped into common shot or common receiver gathers. In some embodiments, seismic data is grouped based on a common domain, such as common midpoint (i.e., Xmidpoint=(Xshot+Xrec)/2, where Xshot corresponds to a position of a shot point and Xrec corresponds to a position of a seismic receiver) and common offset (i.e., Xoffset=Xshot−Xrec).

In some embodiments, seismic data is processed to generate one or more seismic images. For example, seismic imaging may be performed using a process called migration. In some embodiments, migration may transform pre-processed shot gathers from a data domain to an image domain that corresponds to depth data. In the data domain, seismic events in a shot gather may represent seismic events in the subsurface that were recorded in a field survey. In the image domain, seismic events in a migrated shot gather may represent geological interfaces in the subsurface. Likewise, various types of migration algorithms may be used in seismic imaging. For example, one type of migration algorithm corresponds to reverse time migration. In reverse time migration, seismic gathers may be analyzed by: 1) forward modelling of a seismic wavefield via mathematical modelling starting with a synthetic seismic source wavelet and a velocity model; 2) backward propagating the seismic data via mathematical modelling using the same velocity model; 3) cross-correlating the seismic wavefield based on the results of forward modeling and backward propagating; and 4) applying an imaging condition during the cross-correlation to generate a seismic image at each time step. The imaging condition may determine how to form an actual image by estimating cross-correlation between the source wavefield with the receiver wavefield under the basic assumption that the source wavefield represents the down-going wave-field and the receiver wave-field the up-going wave-field.

In Kirchhoff and other migration methods, for example, the imaging condition may include a summation of contributions resulting from the input data traces after the traces have been spread along portions of various isochrones (e.g., using principles of constructive and destructive interference to form the image). For example, Kirchhoff migration function may be based on an integral form of a wave equation that corresponds to pressure wave displacement and a pressure wave velocity as function of three-dimensional space and time. As such, 3D prestack Kirchhoff depth migration may be characterized as the summation of various reflection amplitudes along diffraction traveltime curves to obtain the output seismic images. As such, Kirchhoff algorithms may preprocess input seismic traces, determine traveltime tables for pressure waves using ray-tracing and a velocity model, and migrate these seismic traces. Besides Kirchhoff algorithms, other migration functions are also contemplated such as finite-difference migration, frequency-space migration, and frequency-wavenumber migration, and Stolt migration.

Keeping with migration functions, migration may also include a process of mapping seismic data onto an image that includes reflecting boundaries in the subsurface. Because migration techniques may rely on wavefield propagation estimates in the subsurface, poor velocity estimations may impact migration techniques that output one or more reflectivity maps in the depth domain. For example, poor velocity modeling may result in blurred images due to inaccurately mapping reflecting boundaries to the correct depths. Thus, wave equation migration velocity analysis (WEMVA) may be used to optimize modeling operators that are used to update one or more velocity models. In some embodiments, seismic full-waveform inversion (FWI) is used to determine velocity models by inverting a complete seismic dataset acquired for a particular geological region. FWI techniques may use local optimization approaches in cases where a reliable initial velocity model is available. The velocity model in FWI processes, unlike WEMVA techniques, may generate scattering in various modeling operators. FWI approaches may manage multiple scattering properly, but the FWI process may now experience reflecting errors based on high wavenumbers.

Furthermore, seismic data processing may include various seismic data functions that are performed using various process parameters and combinations of process parameter values. For example, a seismic interpreter may test different parameter values to obtain a desired result for further seismic processing. Depending on the seismic data processing algorithm, a result may be evaluated using different types of seismic data, such as directly on processed gathers, normal moveout corrected stacks of those gathers, or on migrated stacks using a migration function. Where structural information of the subsurface is being analyzed, migrated stacks of data may be used to evaluate seismic noise that may overlay various geological boundaries in the subsurface, such as surface multiples (e.g., strong secondary reflections that are detected by seismic receivers). As such, migrated images may be used to determine impact of noise removal processes, while the same noise removal processes may operate on gather data.

While seismic traces with zero offset are generally illustrated in FIG. 2, seismic traces may be stacked, migrated and/or used to generate an attribute volume derived from the underlying seismic traces. For example, an attribute volume may be a dataset where the seismic volume undergoes one or more processing techniques, such as amplitude-versus-offset (AVO) processing. In AVO processing, seismic data may be classified based on reflected amplitude variations due to the presence of hydrocarbon accumulations in a subsurface formation. With an AVO approach, seismic attributes of a subsurface interface may be determined from the dependence of the detected amplitude of seismic reflections on the angle of incidence of the seismic energy. This AVO processing may determine both a normal incidence coefficient of a seismic reflection, and/or a gradient component of the seismic reflection. Likewise, seismic data may be processed according to a pressure wave's apex. In particular, the apex may serve as a data gather point to sort first break picks for seismic data records or traces into offset bins based on the survey dimensional data (e.g., the x-y locations of the seismic receivers (226) on the earth surface (230)). The bins may include different numbers of traces and/or different coordinate dimensions.

Additionally, seismic imaging may be near the end of a seismic data workflow before an analysis by a seismic interpreter. The seismic interpreter may subsequently derive understanding of the subsurface geology from one or more final migrated images. In order to confirm whether a particular seismic data workflow accurately models the subsurface, a normal moveout (NMO) stack may be generated that includes various NMO gathers with amplitudes sampled from a common midpoint (CMP). In particular, a NMO correction may be a seismic imaging approximation based on calculating reflection traveltimes.

Moreover, pressure waves may undergo seismic attenuation when traveling within a medium, such as the earth's subsurface. For example, seismic attenuation may be an intrinsic property of rocks that relates to energy dissipation as pressure waves propagate through the subsurface. As such, attenuation may result in the decay of wave amplitudes in inelastic media. Several types of seismic attenuation may occur, such as (1) geometrical spreading (i.e., a wavefront radiating from a point source is distributed over a spherical surface of increasing size), (2) scattering or elastic attenuation, and (3) absorption or anelastic attenuation. Scattering may be caused by heterogeneity levels in the subsurface. In particular, scattering may be used to identify rocks containing oil and gas that result in energy attenuation among high frequency seismic waves. Thus, frequency-dependent attenuation, such as scattering, can be used to detect hydrocarbons.

With absorption or anelastic attenuation, energy loss may occur due to anelastic processes or internal friction during wave propagation. More specifically, anelastic attenuation may occur due to shear wave motions associated with lateral movements at interface boundaries, such as water, gas, formations, and grain boundaries. Mechanical energy losses from anelastic attenuation may be converted to heat energy which will eventually cause the total disappearance of the seismic wave. Beyond simple energy losses, anelastic attenuation may also cause a pressure wave to experience pulse broadening with increasing distances. As the wave spreads, anelastic attenuation may thereby remove high frequency components of the pressure wave. In modeling anelastic attenuation, seismic data processing may use an anelastic attenuation factor, often expressed as seismic quality factor Q. The seismic quality factor Q may be determined using Q tomography, where the seismic quality factor Q is inversely proportional to the anelastic attenuation factor. Thus, Q tomography may quantify the effects of anelastic attenuation on the seismic wavelet throughout the subsurface. Quantitative seismic attribute analysis of amplitude versus offset effects is complicated by anelastic attenuation because it is superimposed upon the AVO effects. In some embodiments, anelastic attenuation includes additional information about the lithology and reservoir conditions of a geological region, such as porosity, saturation and pore pressure levels. Thus, attenuation models may provide a useful reservoir characterization tool. In some embodiments, for example, an attenuation model is a Q model that includes descriptions of different attenuation parameters within a geological region. As such, an attenuation model may be determined using final attenuated traveltimes from an iterative process.

Furthermore, an accurate seismic quality factor Q may be used to both compensate seismic data for the loss of information from attenuation and for seismic attribute analysis. Using Q tomography, for example, a seismic interpreter may generate various attenuation models from various geological regions. These attenuation models (also called Q models) may include three-dimensional frequency-independent regional models of the subsurface for either a p-wave (i.e., based on a seismic quality factor Qₚ) or an s-wave (i.e., based on a seismic quality factor Qₛ). In some embodiments, Q tomography uses a ray-based method based on pre-stack migrated common image gathers for estimating the quality factor Q. Likewise, various Q processing techniques may be implemented within other seismic data processes, such as Q full-waveform inversion or Q migration.

In seismic data processing, acquired seismic data R(f) may be determined in terms of a source wavelet S(f), a frequency independent factor G (which may include geometrical spreading, radiation patterns, and reflection coefficients, etc.), and a seismic attenuation effect H(f) in the frequency domain. In some embodiments, the acquired seismic data is expressed using the following equation:

$$R ( f ) = G H ( f ) S ( f ) \qquad Equation ( 1 )$$

Seismic attenuation effect is accumulative along a ray path and may be determined solely by the accumulation of seismic attenuated time t*. In some embodiments, for example, the seismic attenuation effect H(f) is expressed using following Equation (2) and seismic attenuated time t* is expressed using following Equation (3), respectively:

$$H ( f ) = exp ( - f {\int }_{l} π / ( Qv ) dl ) = exp ( - π f {\int }_{l} d {t}^{*} ) \qquad Equation ( 2 )$$

$${t}^{*} = {\int }_{l} 1 / ( Qv ) dl \qquad Equation ( 3 )$$

where Q is a seismic quality factor, v is a seismic velocity, l is a ray path, and f is a frequency component of the seismic wave. Attenuated time t* may integrate the effects of both seismic velocity v and the seismic quality factor Q along the ray path l in an absorptive medium.

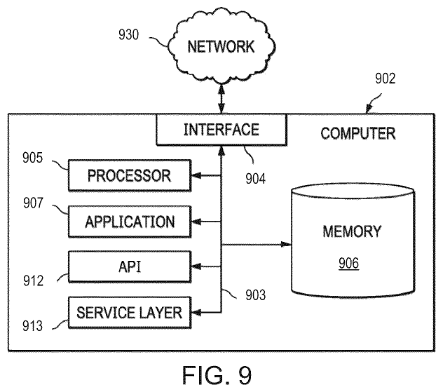

Turning to the seismic interpreter (261), a seismic interpreter (261) (also called a “seismic processing system”) may include hardware and/or software with functionality for storing the seismic volume (290), well logs, core sample data, and other data for seismic data processing, well data processing, and other data processes accordingly. In some embodiments, the seismic interpreter (261) may include a computer system that is similar to the computer (902) described below with regard to FIG. 9 and the accompanying description. While a seismic interpreter may refer to one or more computer systems that are used for performing seismic data processing, the seismic interpreter may also refer to a human analyst performing seismic data processing in connection with a computer. While the seismic interpreter (261) is shown at a seismic surveying site, in some embodiments, the seismic interpreter (261) may be remote from a seismic surveying site.

Turning to geosteering, geosteering may be used to position the drill bit or drill string of the drilling system relative to a boundary between different subsurface layers (e.g., overlying, underlying, and lateral layers of a pay zone) during drilling operations. In particular, measuring rock properties during drilling may provide the drilling system with the ability to steer the drill bit in the direction of desired hydrocarbon concentrations. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling. Likewise, a well path of a wellbore may be updated by a control system using a geophysical model (e.g., a model based on one or more seismic images). For example, a control system may communicate geosteering commands to the drilling system based on well data updates that are further adjusted by a simulator using a geophysical model. As such, the control system may generate one or more control signals for drilling equipment (or a logging system may generate for logging equipment) based on an updated well path design and/or a geophysical model.

Keeping with FIG. 2, a simulator (e.g., a reservoir simulator or a seismic interpreter (261)) may include hardware and/or software with functionality for generating and/or updating one or more machine-learning models to determine traveltime data, migrated seismic data, velocity model data, attenuation model data, and/or other simulation data. Examples of machine-learning models may include random forest models and artificial neural networks, such as convolutional neural networks, fully-connected neural networks, deep neural networks, and recurrent neural networks. Machine-learning models may also include support vector machines, decision trees, inductive learning models, deductive learning models, supervised learning models, unsupervised learning models, reinforcement learning models, and the like. In a deep neural network, for example, a layer of neurons may be trained on a predetermined list of features based on the previous network layer's output. Thus, as data progresses through the deep neural network, more complex features may be identified within the data by neurons in later layers. In some embodiments, two or more different types of machine-learning models are integrated into a single machine-learning architecture, e.g., a machine-learning model may include a random forest model and various neural networks. In some embodiments, a simulator may generate augmented data or synthetic data to produce a large amount of interpreted data for training a particular model.

In some embodiments, various types of machine-learning algorithms may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean-squared-error (MSE) function, a similarity function, etc., where the error function may be used as a feedback mechanism for tuning weights in the machine-learning model.

In some embodiments, a machine-learning model is trained using multiple epochs. For example, an epoch may be an iteration of a model through a portion or all of a training dataset. As such, a single machine-learning epoch may correspond to a specific batch of training data, where the training data is divided into multiple batches for multiple epochs. Thus, a machine-learning model may be trained iteratively using epochs until the model achieves a predetermined criterion, such as predetermined level of prediction accuracy or training over a specific number of machine-learning epochs or iterations. Thus, better training of a model may lead to better predictions by a trained model.

With respect to artificial neural networks, for example, an artificial neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the artificial neural network. Likewise, these weighted data inputs may be summed such that this sum is communicated through a neuron's activation function to other hidden layers within the artificial neural network. As such, the activation function may determine whether and to what extent an output of a neuron progresses to other neurons where the output may be weighted again for use as an input to the next hidden layer.

Turning to fully-connected neural networks, a fully connected neural network may include a series of fully connected layers (e.g., an input layer, one or more hidden layers, and an output layer) that connect each neuron in one layer to every neuron in the next layer. As such, fully-connected neural networks may be referred to as “structurally agnostic” in that there are no special assumptions needed to be made about the input data, such whether the input is an image, a continuous range of values, and/or categorized inputs.

Turning to convolution neural networks, a convolution neural network may obtain images as input data, which may allow encoding certain properties into the network's model architecture. For example, a convolution neural network may include a sequence of hidden layers, where a hidden layer may transform one volume of activations to another set of activations through a differentiable function. Examples of specific hidden layers in a convolution neural network include convolutional layers, pooling layers, fully-connected layers, and/or normalization layers. Likewise, a U-net model or other type of convolutional neural network model may use these different types of layers to produce a particular type of output.

Turning to recurrent neural networks, a recurrent neural network (RNN) may perform a particular task repeatedly for multiple data elements in an input sequence (e.g., a sequence of temperature values or flow rate values), with the output of the recurrent neural network being dependent on past computations. As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, a simulator uses one or more ensemble learning methods to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions.

Turning to random forests, a random forest model may an algorithmic model that combines the output of multiple decision trees to reach a single predicted result. For example, a random forest model may be composed of a collection of decision trees, where training the random forest model may be based on three main hyperparameters that include node size, a number of decision trees, and a number of input features being sampled. During training, a random forest model may allow different decision trees to randomly sample from a dataset with replacement (e.g., from a bootstrap sample) to produce multiple final decision trees in the trained model. For example, when multiple decision trees form an ensemble in the random forest model, this ensemble may determine more accurate predicted data, particularly when the individual trees are uncorrelated with each other. In some embodiments, a random forest model implements a software algorithm that is an extension of a bagging method. As, a random forest model may use both bagging and feature randomness to create an uncorrelated forest of decision trees. Feature randomness (also referred to as “feature bagging”) may generate a random subset of input features. This random subject may thereby result in low correlation among decision trees in the random forest model. In a training operation for a random forest model, a training operation may search for decision trees that provide the best split to subset particular data, such as through a Classification and Regression Tree (CART) algorithm. Different metrics, such as information gain or mean square error (MSE), may be used to determine the quality of a data split for various decision trees.

Keeping with random forests, a random forest model may be a classifier that uses data having discrete labels or classes. Likewise, a random forest model may also be used as a random forest regressor to solve regression problems. Depending on the type of problem being addressed by the random forest model, how predicted data is determined may vary accordingly. For a regression task, the individual decision trees may be averaged in a predicted result. For a classification task, a majority vote (e.g., predicting an output based on the most frequent categorical variable) may determine a predicted class. In a random forest regressor, the model may work with data having a numeric or continuous output, which cannot be defined by distinct classes.

Turning to reinforcement learning, a simulator may perform one or more reinforcement learning algorithms using a reinforcement learning system to train a machine-learning model. In particular, a reinforcement learning algorithm may be a type of method that autonomously learns agent policies through multiple iterations of trials and evaluations based on observation data. The objective of a reinforcement learning algorithm may be to learn an agent policy π that maps one or more states of an environment to an action so as to maximize an expected reward J(π). A value reward may describe one or more qualities of a particular state, agent action, and/or trajectory at particular time within an operation, such as an electric power generation operation. As such, a reinforcement learning system may include hardware and/or software with functionality for implementing one or more reinforcement learning algorithms. For example, a reinforcement learning algorithm may train a policy to make a sequence of decisions based on the observed states of the environment to maximize the cumulative reward determined by a reward function. For example, a reinforcement learning algorithm may employ a trial-and-error procedure to determine one or more agent policies based on various agent interactions with a complex environment, such as a geological subsurface with various geological interfaces and different formations. As such, a reinforcement learning algorithm may include a reward function that teaches a particular action selection engine to follow certain rules, while still allowing the reinforcement learning model to retain information learned from previous simulations.

In some embodiments, one or more components in a reinforcement learning system are trained using a training system. For example, an agent policy and/or a reward function may be updated through a training process that is performed by a machine-learning algorithm. In some embodiments, historical data, augmented data, and/or synthetic data may provide a supervised signal for training an action selector engine, an agent policy, and/or a reward function, such as through an imitation learning algorithm. In another embodiment, an interactive expert may provide data for adjusting agent policies and/or reward functions.

Turning to deep reinforcement learning, deep reinforcement learning may combine various machine-learning models (e.g., artificial neural networks) with a framework of reinforcement learning that helps agents learn how to reach their goals. That is, deep reinforcement learning may use both function approximation and target optimization in order to map various states and actions to specific rewards. For example, artificial neural networks as used in computer vision, natural language processing, and time series predictions may be combined with reinforcement learning algorithms.

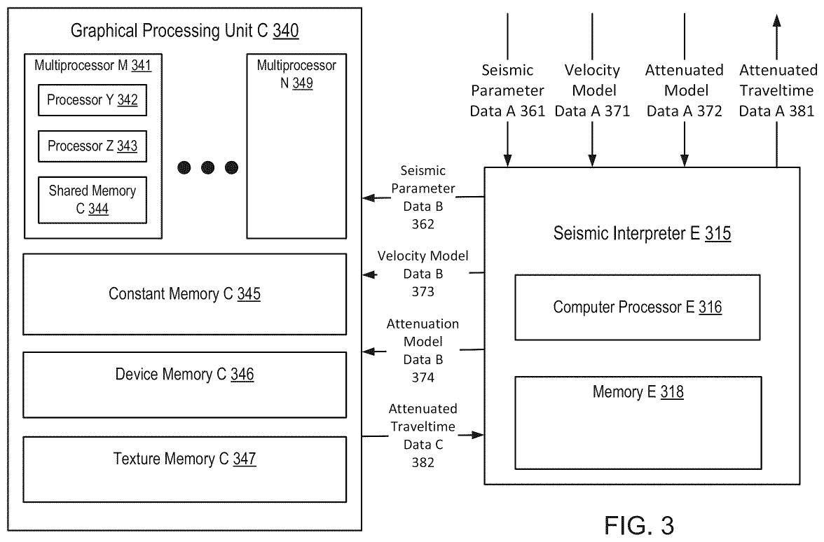

Turning to FIG. 3, FIG. 3 shows a schematic diagram in accordance with one or more embodiments. As illustrated in FIG. 3, a central processing unit (CPU) (e.g., computer processor E (316)) may be coupled to one or more graphical processing units (e.g., graphical processing unit (GPU) C (340)) to perform one or more seismic data processing operations, e.g., one or more traveltime computation functions and/or prediction functions using machine learning. In particular, a GPU may include various hardware, such as a set of multiprocessors (e.g., multiprocessor M (341), multiprocessor N (349)), where a respective multiprocessor may include multiple individual processors (e.g., processor Y (342), processor Z (343), which may be referred to as “cores”), and one or more shared memories (e.g., shared memory C (344)). As such, a GPU may perform a specific seismic operation that may be referred to as a “kernel” that is performed using multiple hardware threads operating in parallel. For example, a GPU may execute the kernel using one or more thread blocks, where a thread block includes a group of single instruction, multiple data (SIMD) threads. As such, multiple thread blocks may be executed by a single multiprocessor concurrently on a GPU. Thus, GPUs may include functionality for accelerating image generation, which may also make GPUs suitable hardware for executing parallel processing in order to perform seismic data operations that include complex computations. A processor may be a parallel processor and similar to the computer processor (905) described below in FIG. 9 and the accompanying description. In particular, the term “parallel processor” may refer to multiprocessors, individual processors, and computer processors that operate in parallel in a processing operation.

In some embodiments, a seismic interpreter operates as a CPU, such as seismic interpreter E (315), and uses one or more GPUs (e.g., GPU C (340)) to determine attenuated traveltime data (e.g., attenuated traveltime data A (381), attenuated traveltime data C (382)) using a prediction operation and/or a computation function in connection with one or more Eikonal functions. In regard to seismic interpreter E (315), for example, the seismic interpreter E (315) includes a computer processor E (316) and a memory (318) that stores all or a portion of seismic parameter data (e.g., seismic parameter data A (361), seismic parameter data B (362)), velocity model data (e.g., velocity model data A (371), velocity model data B (373)), and/or attenuated model data (e.g., attenuated model data A (372), attenuated model data B (374)). After collecting attenuated traveltime data from the GPUs performing the migration algorithm or migration function, the seismic interpreter E (315) may transmit the results to an external source for storage and/or analysis.

Keeping with GPUs, a GPU may include different types of memory hardware, such as register memory, shared memory, device memory, constant memory, texture memory, etc. For example, register memory and shared memory (e.g., shared memory C (344)) may be disposed on an actual GPU chip, while other types of memory may be separate components in the GPU. In particular, register memory may only be accessible to the hardware thread that wrote its memory values, which may only last throughout the respective thread's lifetime. On the other hand, shared memory may be accessible to all hardware threads within a thread block and shared memory values may exist for the duration of the thread block (e.g., shared memory enables hardware threads to communicate and share data between one another). Device memory (e.g., device memory C (346)) may be global memory that is accessible to any hardware threads within a GPU's application as well as devices outside the GPU, such as a seismic interpreter or seismic processing system. Device memory may be allocated by a host, for example, and may survive until the host deallocates the memory. Constant memory (e.g., constant memory C (345)) may be a read-only memory device that provides memory values that do not change over the course of a kernel execution (e.g., constant memory may provide data faster than device memory and thus reduce memory bandwidth). Texture memory (e.g., texture memory C (347)) may be another read-only memory device that is similar to constant memory, where the memory reads in texture memory may be limited to physically adjacent hardware threads, e.g., those hardware threads in a warp.

In some embodiments, multiple GPUs, a central processing unit, and/or one or more seismic interpreters may communicate with each other using a peer-to-peer (P2P) communication protocol. For example, two GPUs may be attached to the same PCIe bus in a seismic interpreter and communicate directly with each other. Thus, over a P2P communication protocol, a component in a seismic interpreter may access a different memory in another GPU or CPU. In some embodiments, for example, the seismic interpreter E (315) may not store locally traveltime data, but may simply access the device memory C (346) in the GPU C (340) that stores a portion of the computed and/or predicted traveltime data. Likewise, the P2P communication protocol may also enable direct memory transfers between system components.

Throughout this application, “obtain” and similar terminology is used in the context of actively or passively accessing data, such as seismic data. By way of example, a seismic interpreter may “obtain” a particular type of data (e.g., seismic data, well data, geological data, etc.) by actively transmitting a request to a remote server or a local data store to retrieve the specific data. On the other hand, a computer system may “obtain” data as a passive recipient to the data, such as through a user uploading one or more data files to a local storage device coupled to the computer system that is “obtaining” the data. In contrast, “acquire” and similar terminology is used in the context of actively harvesting data from a physical environment through sensors, electronic receivers (such as seismic receivers), and/or other hardware sensing mechanisms.

While FIGS. 1, 2, and 3 show various configurations of components, other configurations may be used without departing from the scope of the disclosure. For example, various components in FIGS. 1, 2, and 3 may be combined to create a single component. As another example, the functionality performed by a single component may be performed by two or more components.

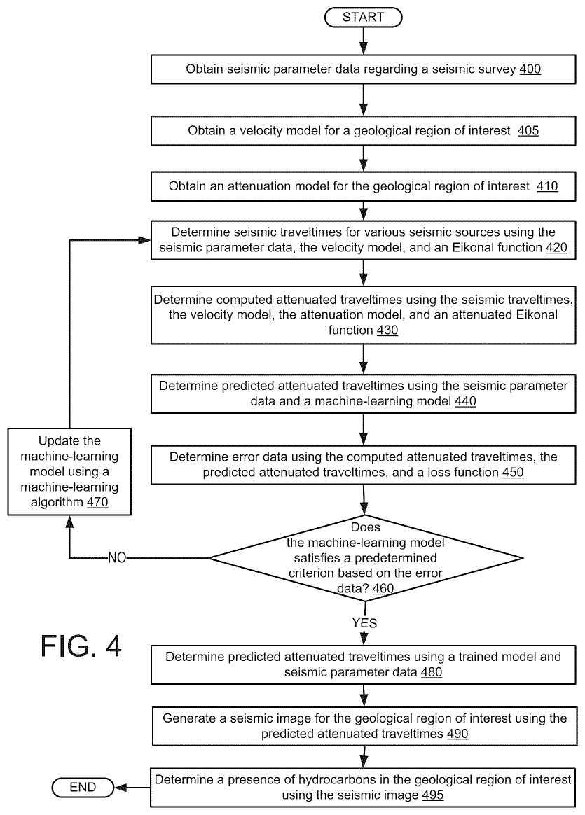

Turning to FIG. 4, FIG. 4 shows a flowchart in accordance with one or more embodiments. Specifically, FIG. 4 describes a general method for determining predicted attenuated traveltimes. One or more blocks in FIG. 4 may be performed by one or more components (e.g., seismic interpreter (261)) as described in FIGS. 1 2, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, seismic parameter data are obtained regarding a seismic survey in accordance with one or more embodiments. For example, seismic parameter data may include seismic source positions for one or more seismic surveys of a geological region of interest. Likewise, seismic parameter data may also include receiver positions as well as grid node data (e.g., grid node numbers and grid space parameters) for computing seismic traveltime data.

In Block 405, a velocity model is obtained for a geological region of interest in accordance with one or more embodiments. The velocity model may be similar to the velocity model described in FIGS. 1 and 2 and the accompanying description. A geological region of interest may be a portion of a geological area or volume that includes one or more formations of interest desired or selected for analysis, e.g., for determining location of hydrocarbons or reservoir development purposes. The seismic data may be similar to the seismic data described above in FIGS. 1 and 2 and the accompanying description.

In Block 410, an attenuation model is obtained for a geological region of interest in accordance with one or more embodiments. For example, a parameter file may be obtained that includes seismic parameter data, velocity model data, and attenuation model data. The attenuation model may be similar to the attenuation model described in FIG. 2 and the accompanying description.

In Block 420, various seismic traveltimes are determined for various seismic sources using seismic parameter data, a velocity model, and an Eikonal function in accordance with one or more embodiments. In particular, seismic traveltimes may describe the time that one or more pressure waves travel from a seismic source's location through the subsurface, such as to a seismic receiver. Seismic traveltimes may correspond to one or more travel-time curves identifying the distance from the seismic source to an observation point and the corresponding traveltime at different locations in the geological region. In some embodiments, seismic traveltimes are determined using one or more Eikonal functions, such as by solving an Eikonal equation. For example, the Eikonal function may be based on the following Eikonal equation expressed below:

$$\vert ∇ t ( x ) \vert = \frac{1}{\vert v ( x ) \vert} \qquad Equation ( 4 )$$

where t is the traveltime, v is seismic velocity, ∇ is gradient operator, and x is a displacement vector of seismic source locations.

In some embodiments, seismic traveltimes are determined through a finite difference approach using grid nodes and solving one or more Eikonal functions. For example, a geological region of interest may be divided according to a grid space with various grid nodes corresponding to different locations within the geological region. As such, a grid model may be two-dimensional or three-dimensional grid space, where grid nodes may provide discretized local solutions for determining seismic traveltimes or attenuated traveltimes during a seismic processing operation. While a grid may correspond to a regular grid, irregular grids are also contemplated with nonuniform grids, tree-based data structures, or triangulated meshes.

Furthermore, various types of finite difference methods may be used, such as simple one-step methods such as a Euler method (e.g., a Forward Euler method or a Backward Euler method), a trapezoid method, or a midpoint method, as well as more complex multi-step methods such as an Adams' method (e.g., Adams-Bashforth method or Adams-Bashforth method). Finite difference methods may also include non-linear methods such as Runge-Kutta methods that can be used to solve both linear and non-linear ordinary differential equations. Finite difference methods may also be implicit methods or explicit difference methods. An explicit finite difference method may use known values of an Eikonal function at the current time step to calculate the approximate value at the next time step, such as through a forward modelling function. An implicit method may use the approximate values at the next time step to calculate the value at the current time step. For example, an implicit finite difference method may use a Newton-Raphson method for solving non-linear algebraic equations within the corresponding finite difference method.

In some embodiments, traveltimes are determined using a fast sweeping method that advances wavefronts within a particular grid using iterative sweeping based on alternating sweeping orders. For example, the iterations may be Gauss-Seidel iterations that determine individual solutions at respective grid nodes during a particular sweep. In other words, an entire grid may be successively sweeped or traversed following a specific sweeping order (i.e., by alternating directions of sweeps with respect to a grid). Thus, a fast sweeping method may be performed until no grid values are further updated by a particular fast sweeping iteration, thus providing a global solution to the attenuated traveltimes.

In Block 430, various computed attenuated traveltimes are determined using various seismic traveltimes and an attenuated Eikonal function in accordance with one or more embodiments. In particular, a local solution of the attenuated traveltimes may be determined using various grid nodes and a forward modeling function. In some embodiments, for example, an attenuated Eikonal function may be an equation as expressed below:

$$∇ {t}^{*} ( x ) \cdot ∇ t ( x ) = \frac{q}{{v}^{2}} \qquad Equation ( 5 )$$

where t* is the attenuated traveltime, q=1/Q is inverse quality factor, v is seismic velocity. For example, the inverse quality factor may be proportional to the attenuation factor. A larger q means stronger attenuation. Moreover, a source term may be located at s=(sₓ,s_{z}), where t*(sₓ,s_{z})=0. In the Equation 6 below, the partial derivatives of the traveltime with respect to the spatial variables can be approximately expressed by the first-order finite difference as follows:

$$\begin{matrix}\frac{\partial t}{\partial x} = ( \frac{{t}_{i , j} - {t}_{x min}}{Δ x} ) {s}_{x} , \frac{\partial t}{\partial z} = ( \frac{{t}_{i , j} - {t}_{z min}}{Δ z} ) {s}_{z} , \\ \begin{matrix}i = 2 , 3 , … , I - 1 , & j = 2 , 3 , … , J - 1\end{matrix}\end{matrix} \qquad Equation ( 6 )$$

where Δx and Δz denote grid spacing along x and z directions, respectively, t_{i,j} denotes the seismic traveltime at a grid node (i,j), and additional definitions are below:

$$\begin{matrix}{t}_{x min} = min ( {t}_{i - 1 , j} , {t}_{i + 1 , j} ) , & {t}_{z min} = min ( {t}_{i , j - 1} , {t}_{i , j + 1} ) ,\end{matrix} \qquad Equation ( 7 )$$

$${s}_{x} = \{ \begin{matrix}+ 1 , if {t}_{x min} = {t}_{i + 1 , j} \\ - 1 , if {t}_{x min} = {t}_{i - 1 , j}\end{matrix} , {s}_{z} = \{ \begin{matrix}+ 1 , if {t}_{z min} = {t}_{i , j + 1} \\ - 1 , if {t}_{z min} = {t}_{i , j - 1}\end{matrix} \qquad Equation ( 8 )$$

In some embodiments, computations for determining attenuated traveltimes may be performed using various parallel processors to reduce computational runtime, e.g., in a GPU/CPU hybrid platform. By having a central processing unit (CPU) and graphical processing units (GPUS) (or other parallel processors) collaborate on a seismic data operation (e.g., Q full-waveform inversion or Q tomography), various computational bottlenecks may be prevented in the data processing. For example, a parallel processing network may generate an attenuation model using a finite difference method performed by different parallel processors. In particular, the term “parallel processor” may refer to multiprocessors, individual processors, and computer processors that operate in parallel in a processing operation.

In Block 440, predicted attenuated traveltimes are determined using seismic parameter data and a machine-learning model in accordance with one or more embodiments. For example, the machine-learning model may be a deep neural network that obtain seismic parameter data, velocity model data, and/or attenuation model data as inputs, while outputting predicted attenuated traveltimes for different locations in a geological region. In some embodiments, various attenuated traveltimes t*(x,z) may be approximated by a multilayer deep feed-forward neural network [symbol] , i.e., t*(x,z)≈ [symbol] (x,z)= [symbol] (x,z;θ), where (x,z) are network inputs, [symbol] (x,z) is network output, and θ expresses the trainable parameters of the network. For more information on machine-learning models, see FIG. 2 and the accompanying description above.

In Block 450, error data are determined using various computed attenuated traveltimes, various predicted attenuated traveltimes, and a loss function in accordance with one or more embodiments. To solve Equation 6 above using a machine-learning network, a machine-learning model may be trained using a loss function that minimizes the residual of an attenuated Eikonal function (e.g., Equation 5) at a selected set of training points through updating various machine-learning parameters, such as biases and weights. As such, the partial derivatives of attenuated traveltimes may be determined by the expressions in the Equations 7 and 8. In some embodiments, the loss function is a mean-squared-error (MSE) norm as expressed by the following equation:

$$L = \frac{1}{{N}_{I}} {\sum }_{i , j} {‖ \frac{\partial t}{\partial {x}_{i}} \frac{\partial {t}^{*}}{\partial {x}_{i}} + \frac{\partial t}{\partial {z}_{j}} \frac{\partial {t}^{*}}{\partial {z}_{j}} - \frac{{q}_{i , j}}{{v}_{i , j}^{2}} ‖}^{2} + \frac{1}{{N}_{I}} {\sum }_{i , j} {‖ H ( - {t}^{*} ( {x}_{i} , {z}_{j} ) ) \vert {t}^{*} ( {x}_{i} , {z}_{j} ) \vert ‖}^{2} + {‖ {t}^{*} ( {s}_{x} , {s}_{z} ) - 0 ‖}^{2} \qquad Equation ( 9 )$$

where the first term of Equation 9 indicates the validity of the attenuated Eikonal function on a given set of training points with N_{I} as the number of selected points. The second term in Equation 9 forces the solutions to be positive using the Heaviside function H to penalize negative solutions. The third term in Equation 9 requires the solution to be zero at the point source (sₓ,s_{z}).

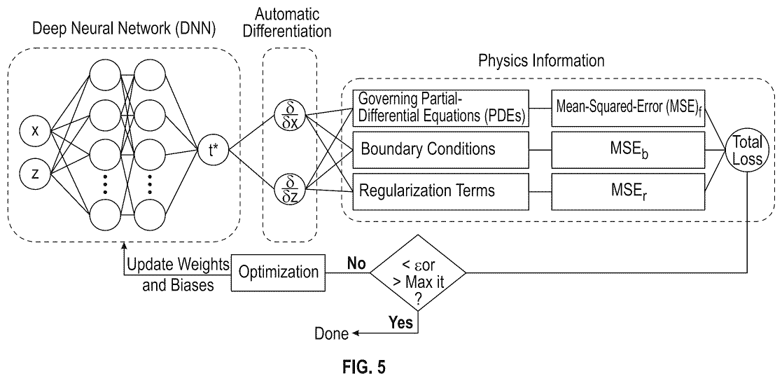

Furthermore, the machine-learning model may be randomly initialized for each point in the training dataset and the residual is determined using a loss function, such as Equation 10. Based on the residual, the machine-learning model may adjust various weights and biases to produce an updated model where the predicted attenuated travel times adhere to the underlying attenuated Eikonal function. It is noted that this machine-learning model may be trained without any labeled dataset and satisfies the physical laws governing the transmission pressure waves through the subsurface. FIG. 5 provides an illustration of a deep learning framework for training a machine-learning model to predict attenuated traveltimes in one or more embodiments.

In Block 460, a determination is made whether a machine-learning model satisfies a predetermined criterion based on error data in accordance with one or more embodiments. In particular, the predetermined criterion may be a stopping criterion such a convergence criterion or a predetermined degree of accuracy. Likewise, other criteria are contemplated, such as a specific number of machine-learning epochs. If it is determined that a predetermined criterion is satisfied, the process may proceed to Block 470. If it is determined that the predetermined criterion is not satisfied, then the process proceeds to Block 480.

In Block 470, a machine-learning model is updated using a machine-learning algorithm in accordance with one or more embodiments. For example, a machine-learning model may be updated using gradients in a backpropagation algorithm or synthetic gradients. The model update may include adjusting weights and/or biases within the machine-learning model.

In Block 480, various predicted attenuated traveltimes are determined for a geological region of interest using a trained model and seismic parameter data in accordance with one or more embodiments. Rather than computing attenuated traveltimes for an entire geological region, a machine-learning learning model may be trained using only a portion of the entire attenuated traveltime dataset. Thus, the remaining attenuated traveltimes may be determined faster and using less computing resources (e.g., memory and processing power) than a conventional method based on one or more Eikonal functions.

In Block 490, a seismic image is generated for a geological region of interest using various predicted attenuated traveltimes in accordance with one or more embodiments. Using attenuated traveltimes for a geological region, a seismic image may be obtained for the geological region of interest. For example, predicted attenuated traveltimes may be used to determine velocity model updates, reflection interfaces, as well as complex geological formations in the geological region of interest.

In some embodiments, the seismic image provides a spatial and depth illustration of a subsurface formation for various practical applications, such as predicting hydrocarbon deposits, predicting wellbore paths for geosteering, etc. In some embodiments, the attenuation model is used to enhance the resolution of the seismic images. By compensating for amplitude attenuation with an attenuation model of the visco-elastic attenuation model type, seismic data may provide true relative-amplitude information for amplitude inversion, subsequent reservoir characterization, and correct timings for lithological identification.

In Block 495, a presence of hydrocarbons are determined in a geological region of interest using a seismic image in accordance with one or more embodiments.

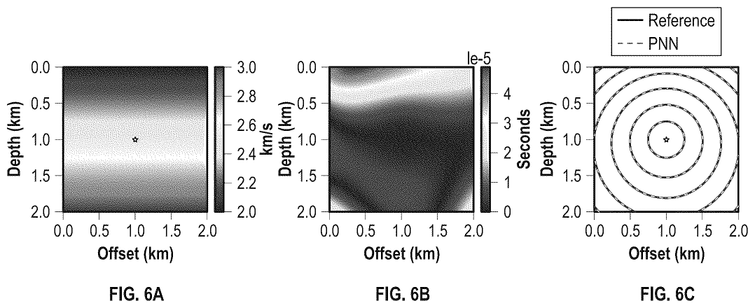

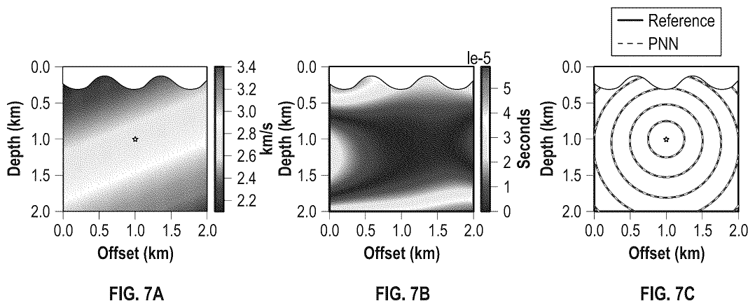

Turning to FIGS. 6 and 7, FIGS. 6 and 7 provide examples in accordance with one or more embodiments. For example, an example deep neural network is trained using a training dataset that includes training points totaling 25% of the total grid nodes, where the grid spacing is 20 meters in an x-direction and z-direction. The deep neural network is a 10-hidden-layer neural network with 20 neurons on each hidden layer. In FIG. 6A, the first example is a 2D vertically linear velocity model with a constant Q=100. The seismic source is located in the center of the velocity model as shown in FIG. 6A. The velocity profile is v=2.0+0.5z, and its corresponding traveltime has the analytical solution. The reference attenuated time is determined by multiplying the traveltime with inverse quality factor 1/Q=0.01. FIG. 6B shows an error map between predicted attenuated traveltime data and reference results that look quite small. FIG. 6C shows a comparison of seismic attenuated traveltimes indicating that the deep neural network matches the reference data very well.

In FIG. 7A, a second example is shown where a 2D vertically and horizontally linear velocity model with irregular topography and constant Q=100. The seismic source is located in the same position. The velocity profile may be v=2.0+0.2x+0.5z, and its corresponding traveltime also has the analytical solution. Similarly, the reference attenuated traveltimes are determined by multiplying the traveltime with the inverse quality factor. FIG. 7B shows an error map and FIG. 7C shows a comparison indicating that the corresponding deep neural network provides a satisfactory result.

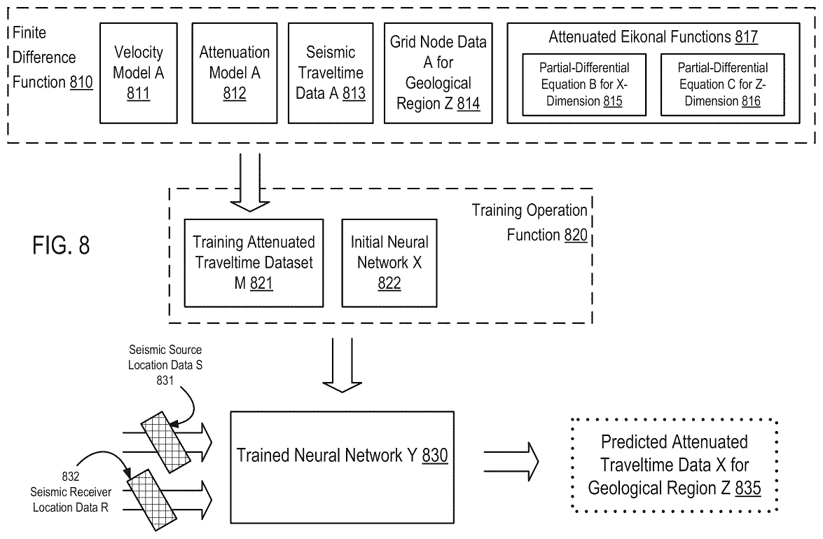

Turning to FIG. 8, FIG. 8 provides an example of training a machine-learning model to predict attenuated traveltime data in accordance with one or more embodiments. The following example is for explanatory purposes only and not intended to limit the scope of the disclosed technology. In FIG. 8, a seismic interpreter (not shown) obtains a velocity model A (811), an attenuated model A (812), seismic traveltime data A (813), grid node data A (814), and various attenuated Eikonal functions (817) for modeling a geological region Z. In particular, the attenuated Eikonal functions (817) include partial-differential equations (815, 816) for the x-dimension and z-dimension, respectively. Using a finite difference function (810), the seismic interpreter uses the input data (811, 812, 813) and the grid node data A (814) to determine simulated solutions to partial-differential equation B (815) and partial-differential equation C (816), respectively. These simulated solutions are computed attenuated traveltimes that form a training attenuated traveltime dataset M (821). Using the training attenuated traveltime dataset M (821), a training operation function (820) is performed on an initial neural network X (822) to produce a trained neural network Y (830). After training, the training neural network Y (830) can determine predicted attenuated traveltime data X (835) for geological region Z using seismic source location data S (831) and seismic receiver location data R (832) as inputs to an input layer.

### Computer System

Embodiments may be implemented on a computer system. FIG. 9 is a block diagram of a computer system used to provide computational functionalities associated with described algorithms, methods, functions, processes, flows, and procedures as described in the instant disclosure, according to an implementation. The illustrated computer (902) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is communicably coupled with a network (930) or cloud. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) or cloud from a client application (for example, executing on another computer (902)) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or other suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904 includes logic encoded in software or hardware (or a combination of software and hardware) and operable to communicate with the network (930) or cloud. More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), each computer (902) communicating over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

In some embodiments, the computer (902) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining seismic parameter data based on a seismic survey regarding a geological region of interest;
determining, by a computer processor, a plurality of seismic traveltimes using the seismic parameter data, a first Eikonal function, and a velocity model for the geological region of interest;
determining, by the computer processor, a first plurality of computed attenuated traveltimes using an attenuation model for the geological region of interest, an attenuated Eikonal function, the plurality of seismic traveltimes, and the seismic parameter data;
determining, by the computer processor, a first plurality of predicted attenuated traveltimes using a first machine-learning model and the seismic parameter data;
determining, by the computer processor, error data using a loss function based on a mismatch between the first plurality of predicted attenuated traveltimes and the first plurality of computed attenuated traveltimes;
determining, by the computer processor, whether the first machine-learning model satisfies a predetermined criterion based on the error data;
updating, by the computer processor, the first machine-learning model using a machine-learning algorithm to produce an updated machine-learning model in response to the error data failing to satisfy the predetermined criterion; and
determining, by the computer processor, a second plurality of predicted attenuated traveltimes using the updated machine-learning model and the seismic parameter data.

2. The method of claim 1, further comprising:
determining a plurality of grid nodes in the geological region of interest using the seismic parameter data, wherein the plurality of grid nodes comprises a first subset of grid nodes and a second subset of grid nodes;
determining a second plurality of computed attenuated traveltimes using the attenuation model, the attenuated Eikonal function, the plurality of seismic traveltimes, and the seismic parameter data to produce a training dataset,
wherein the second plurality of computed attenuated traveltimes are determined using a finite-difference method and the first subset of grid nodes,
wherein the first machine-learning model is trained using the training dataset and the machine-learning algorithm to produce a trained model; and
determining a third plurality of predicted attenuated traveltimes using the trained model, the seismic parameter data, and the second subset of grid nodes.

3. The method of claim 1,
wherein the error data is based a mismatch between the first plurality of computed attenuated traveltimes and the first plurality of predicted attenuated traveltimes for a plurality of partial-differential equations and, and
wherein the loss function is a mean-squared-error (MSE) norm function.

4. The method of claim 1,
wherein the error data comprises a first contribution and a second contribution,
wherein the first contribution is based on a plurality of boundary conditions and a first mismatch between the first plurality of computed attenuated traveltimes and the first plurality of predicted attenuated traveltimes, and
wherein the second contribution is based on a plurality of regularization terms and a second mismatch between the first plurality of computed attenuated traveltimes and the first plurality of predicted attenuated traveltimes.

5. The method of claim 1,
wherein the seismic parameter data comprises a plurality of seismic source locations, a plurality of seismic receiver locations, and grid data, and
wherein the grid data comprises a plurality of grid nodes disposed between a respective seismic source among a plurality of seismic sources and a respective seismic receiver among a plurality of seismic receivers.

6. The method of claim 1, further comprising:
determining a training dataset comprising a second plurality of computed attenuated traveltimes that are determined using the attenuated Eikonal function; and
performing a training operation of a second machine-learning model using the training dataset and the machine-learning algorithm,
wherein the second machine-learning model is updated iteratively using a plurality of machine-learning epochs until the predetermined criterion is satisfied.

7. The method of claim 1,
wherein the first machine-learning model is an artificial neural network comprising an input layer, a plurality of hidden layers, and an output layer,
wherein the machine-learning algorithm is a backpropagation algorithm, and
wherein the predetermined criterion is a predetermined level of accuracy.

8. The method of claim 1,
wherein the attenuation model is a Q model that describes a plurality of seismic quality factor values for the geological region of interest.

9. The method of claim 1, further comprising:
acquiring, using a seismic surveying system comprising a plurality of seismic receivers and a seismic source, seismic data regarding the geological region of interest,
wherein the velocity model and the seismic parameter data are based on the seismic data.

10. The method of claim 1, further comprising:
generating a seismic image for the geological region of interest based on the second plurality of predicted attenuated traveltimes;
determining, using one or more frequency-dependent attenuation regions in the attenuation model, a plurality of interfaces within the geological region of interest; and
determining, using the plurality of interfaces, a presence of hydrocarbons in the geological region of interest.

11. The method of claim 1, further comprising:
generating a seismic image for the geological region of interest based on the second plurality of predicted attenuated traveltimes;
determining a well path in the geological region of interest using the seismic image; and
performing, using a drilling system, a drilling operation based on the well path.

12. A system, comprising:
a parallel processing network comprising a plurality of parallel processors; and
a seismic interpreter comprising a computer processor, wherein the seismic interpreter is coupled to the parallel processing network, the seismic interpreter being configured to perform a method comprising:
obtaining seismic parameter data based on a seismic survey regarding a geological region of interest;
determining a plurality of seismic traveltimes using the seismic parameter data, a first Eikonal function, and a velocity model for the geological region of interest;
determining a first plurality of computed attenuated traveltimes using an attenuation model for the geological region of interest, an attenuated Eikonal function, the plurality of seismic traveltimes, and the seismic parameter data;
determining a first plurality of predicted attenuated traveltimes using a first machine-learning model and the seismic parameter data;
determining error data using a loss function based on a mismatch between the first plurality of predicted attenuated traveltimes and the first plurality of computed attenuated traveltimes;
determining whether the first machine-learning model satisfies a predetermined criterion based on the error data;
updating the first machine-learning model using a machine-learning algorithm to produce an updated machine-learning model in response to the error data failing to satisfy the predetermined criterion; and
determining a second plurality of predicted attenuated traveltimes using the updated machine-learning model and the seismic parameter data.

13. The system of claim 12, wherein the method further comprises:
determining a plurality of grid nodes in the geological region of interest using the seismic parameter data, wherein the plurality of grid nodes comprises a first subset of grid nodes and a second subset of grid nodes;
determining a second plurality of computed attenuated traveltimes using the attenuation model, the attenuated Eikonal function, the plurality of seismic traveltimes, and the seismic parameter data to produce a training dataset,
wherein the second plurality of computed attenuated traveltimes are determined using a finite-difference method and the first subset of grid nodes,
wherein the first machine-learning model is trained using the training dataset and the machine-learning algorithm to produce a trained model; and
determining a third plurality of predicted attenuated traveltimes using the trained model, the seismic parameter data, and the second subset of grid nodes.

14. The system of claim 12,
wherein the error data is based a mismatch between the first plurality of computed attenuated traveltimes and the first plurality of predicted attenuated traveltimes for a plurality of partial-differential equations and, and
wherein the loss function is a mean-squared-error (MSE) norm function.

15. The system of claim 12,
wherein the error data comprises a first contribution and a second contribution,
wherein the first contribution is based on a plurality of boundary conditions and a first mismatch between the first plurality of computed attenuated traveltimes and the first plurality of predicted attenuated traveltimes, and
wherein the second contribution is based on a plurality of regularization terms and a second mismatch between the first plurality of computed attenuated traveltimes and the first plurality of predicted attenuated traveltimes.

16. The system of claim 12, wherein the method further comprises:
determining a training dataset comprising a second plurality of computed attenuated traveltimes that are determined using the attenuated Eikonal function; and
performing a training operation of a second machine-learning model using the training dataset and the machine-learning algorithm,
wherein the second machine-learning model is updated iteratively using a plurality of machine-learning epochs until the predetermined criterion is satisfied.

17. The system of claim 12, wherein the method further comprises:
generating a seismic image for the geological region of interest based on the second plurality of predicted attenuated traveltimes;
determining, using one or more frequency-dependent attenuation regions in the attenuation model, a plurality of interfaces within the geological region of interest; and
determining, using the plurality of interfaces, a presence of hydrocarbons in the geological region of interest.

18. The system of claim 12,
wherein at least one of the plurality of parallel processors is disposed in a graphical processing unit (GPU).

19. The system of claim 12, further comprising:
a seismic surveying system comprising a plurality of seismic receivers and a seismic source,
wherein the seismic surveying system is coupled to the seismic interpreter, and
wherein the seismic surveying system is configured to acquire seismic data regarding the geological region of interest, and
wherein the velocity model and the seismic parameter data are based on the seismic data.

20. The system of claim 12, further comprising:
a drilling system comprising a drill bit and a drill string, the drilling system being coupled to the seismic interpreter,
wherein the seismic interpreter is configured to generate a seismic image based on the second plurality of predicted attenuated traveltimes, and
wherein the drilling system is configured to perform a drilling operation based on a well path that is based on the seismic image.
